(19) United States
(12) Patent Application Publication
(10) Pub. No.: US 2006/0167677 A1
(43) Pub. Date: Jul. 27, 2006

(54) Mobile communication terminal

(76) Inventor: Albert Bitzer, Ottobeuern (DE)

Correspondence Address: PERMAN & GREEN, 425 POST ROAD, FAIRFIELD, CT, 06824, US

(21) Appl. No.: 10/522,635

(22) PCT Filed: Jul. 30, 2002
(86) PCT No.: PCT/EP02/08476

§ 371 Date: Feb. 9, 2006

(51) Int. Cl. G06F 17/27

(52) U.S. Cl. 704/9

(57) ABSTRACT

The invention relates to a mobile communication terminal, advantageously a mobile phone. According to the invention, the communication terminal includes input means and output means for outputting information to a user at least partially in a natural language. The communication terminal further includes means for storing natural language data for a plurality of natural languages, means for selecting one of the natural languages to be used when outputting information through the output means, and means for editing natural language data.

The present invention relates to a mobile communication terminal using a natural language for inputting and outputting information, and to the personalization of such a mobile communication terminal.

### BACKGROUND ART

During the past few years, cellular terminals have changed appearance from heavy brick formed electronic boxes towards an attractive design. Furthermore, the users want to personalize their phones by using colored, exchangeable covers, certain ringing tones, etc.

During the past years, it has been possible to download operator logos and ringing tones from the Internet due to the Nokia Smart Messaging Platform described in the “Smart Messaging Specification”, revision 1.0.0; Sep. 15, 1997.

In U.S. Pat. No. 6,094,587, there is described a method for programming a ringing tone of a telephone in a format that may be transferred from one telephone to another, e.g., in a short message.

U.S. Pat. No. 5,479,476 describes the use of profiles in mobile terminals whereby the user by means of a few key presses may change the alerting of the terminal in order to fit into the requirements of the environment. This is very convenient for the user when he moves from a noisy environment, e.g. factory or street, into a silent environment, e.g. a meeting room, a theater, or a restaurant. The users highly appreciate these profiles.

WO 02/19667 describes a communication terminal having a number of user selectable profiles each including a group of user adjustable operating characteristics. These selectable profiles may be transferred from one communication terminal to another included in a message containing a group of user adjustable operating characteristics. When the communication terminal receives this message transmitted via a communication channel, it analyses the message and saves the group of user adjustable operating characteristics as a profile.

### DISCLOSURE OF THE INVENTION

On this background, it is an object of the present invention to provide a mobile communication terminal of the kind referred to initially, which allows personalization of the language sets stored in the mobile communication terminal. This object is achieved in accordance with claim 1 by providing a terminal of the kind that comprises input means, output means for outputting information to a user at least partially in a natural language, means for storing natural language data for a plurality of natural languages, means for selecting one of the natural languages to be used when outputting information through the output means, and means for editing the natural language data.

By allowing the user to edit the language sets, it is possible to adapt the language set to e.g. a dialect, or to a personal interpretation of words and sentences as understood by the user, since the terminology used can be too technical or intellectual. Often, the users do not naturally associate the same meaning to a word or a sentence as the designers of the user interface, and thus, have to think every time when such a term is displayed, what the term is supposed to mean. This can be avoided by allowing the user to edit the terms, words and sentences stored in the language data set.

Preferably, the means for editing the data comprise means for changing and/or replacing words or sentences of the natural language data, similar to standard text editors.

The mobile communication terminal may also comprise means for receiving and/or sending a signal incorporating a natural language data set, so that editable/edited language sets can be downloaded.

The mobile communication terminal may also comprise a display capable of displaying texts and means to select a letter style for a text to be displayed on the display. The display could be a color display whereby the mobile communication terminal comprises means to select a color for a text and/or text background to be displayed.

The mobile communication terminal preferably comprises a keypad, whereby the means for editing is responsive to input from the keypad.

The mobile communication terminal may also comprise a loudspeaker, a microphone means for editing sound signals and means for storing edited sound signals.

The mobile phone may further comprise a number of user selectable profiles and means to assign a language package to a certain profile, so that it becomes easier for the user to change the user interface of the phone in accordance with circumstances.

The means for editing may comprise means for attaching a stored sound signal to a word or to a sentence of said language data, so that e.g. blind people could hear which command or which key has been activated.

Further, the mobile communication terminal may comprise means for attaching a graphical object to a word or sentence of said language data, so that the user may recognize the state of the user interface easier, or users with little reading skills, such as small children, could use the communication terminal easier.

It is yet another object of the present invention to provide a mobile communication terminal of the kind referred to initially, which allows personalization of a language set stored in the mobile communication terminal. This object is achieved in accordance with claim 12 by providing a terminal communication terminal having a number of pre-installed user interface languages, each comprising a set of words, word combinations or sentences associated to a particular message or command and at least one user-editable language.

Preferably, the mobile communication terminal comprises means for copying a preinstalled language into a user language.

The mobile communication terminal may also comprise means for downloading a language into the user language, via cable, infrared or RF communication.

The mobile communication terminal advantageously comprises means to edit the text and/or letter style and/or letter size and/or text orientation and/or text color in the user language.

The mobile communication terminal could further comprise means to attach a graphical object or a stored sound signal to a word, word combination or sentence of said user language.

It is yet another object of the present invention to provide a method of individualizing a user interface of a mobile communication terminal having user interface using at least one natural language data set for inputting and outputting information. This object is achieved in accordance with claim 17 by providing a method of this kind that further comprises the steps of:

providing the mobile communication terminal with an editor for editing the natural language data set,

storing the edited natural language data set in a memory of the mobile communication terminal,

outputting and inputting information using the stored natural language data set.

Further objects, features, advantages and properties of the mobile communication terminal and method of individualizing a user interface according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which

FIG. 1 illustrates a preferred embodiment of a communication terminal according to the invention,

FIG. 2 schematically shows the essential parts of a communication terminal for communication with a cellular network,

FIG. 3 shows a sequence of display for language selection and editing in a preferred embodiment of a communication terminal according to the invention,

FIG. 4 shows another sequence of display for language selection and editing in a preferred embodiment of a communication terminal according to the invention,

FIG. 5 shows a network in which language data sets may be downloaded to the communication terminal according to the invention,

FIG. 6 is a flow diagram for illustrating the procedure for downloading a language data set, and

FIG. 7 shows a sequence of displays for language data set reception in a preferred embodiment of a communication terminal according to the invention.

### DETAILED DESCRIPTION

In the following detailed description, a mobile communication terminal according to the invention in the form of a hand portable phone, preferably a cellular/mobile phone, will be described by the preferred embodiments.

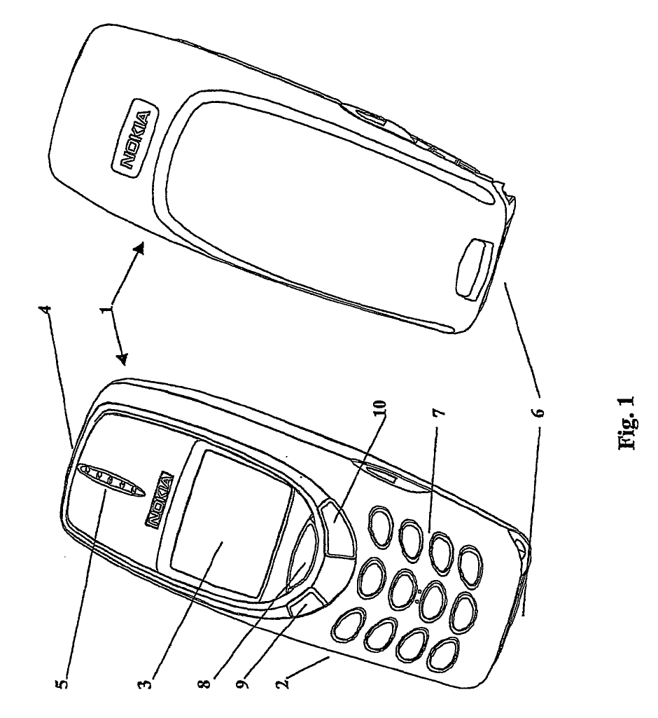

FIG. 1 shows a preferred embodiment of a phone according to the invention, and it will be seen that the phone, which is generally designated by 1, comprises a user interface having a keypad 2, a display 3, an on/off button 4 (present at the top of the phone and therefore not visible in the present view), a speaker 5, and a microphone 6 (openings present at the bottom of the phone and therefore not visible in the present view). The phone 1 according to the preferred embodiment is adapted for communication via a cellular network, such as the GSM 900/1800 MHz network.

According to the preferred embodiment, the keypad 2 has a first group 7 of keys as alphanumeric keys, one softkey 8, a cursor navigation key 10 (scroll up/down), and a “clear”-key 9 for erasing letters in the text in the display 3, for jumping steps down in the menu structure and rejecting calls. The present functionality of the soft key 8 is shown in separate fields (softkey-label) in the display 3 just above the softkey 8. The softkey 8 is a multifunction key and its present function depends on the state of the phone 1. The softkey 8 gives access to the menu, the phonebook and call handling.

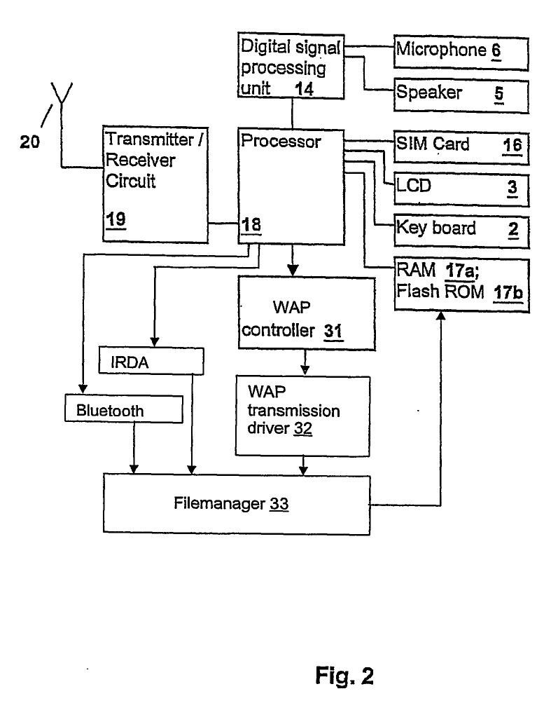

FIG. 2 schematically shows the most important parts of a preferred embodiment of the phone, said parts being essential to the understanding of the invention. The processor 18 controls the communication with the network via the transmitter/receiver circuit 19 and an internal antenna 20.

The microphone 6 transforms the user's speech into analogue signals, the analogue signals formed thereby are A/D converted in an A/D converter (not shown) before the speech is encoded in a digital signal processing unit 14 (DSP). The encoded speech signal is transferred to the processor 18, which i.a. supports the GSM terminal software. The processor 18 also forms the interface to the peripheral units of the apparatus, including a RAM memory 17a and a Flash ROM memory 17b, a SIM card 16, the display 3 and the keypad 2 (as well as data, power supply, etc.). The digital signal-processing unit 14 speech-decodes the signal, which is transferred from the processor 18 to the earpiece 5 via a D/A converter (not shown).

The mobile station main control circuit, including the processor 18 (can be implemented as several micro-controllers) comprises blocks 30-33 for controlling transmission of language sets via infrared communication (IRDA), via high intensity RF communication (WAP), and via low intensity RF communication (Bluetooth) according to the present invention. The system comprises a WAP controller 31, a WAP transmission driver 32, and a file manager 33. The blocks 30-33 can be interpreted as a data processing units of the terminal, which can be formed in full by programming the processor 18. Data received via IR, Bluetooth or WAP is received and processed by the file manager 33. The file manager detects the type of data received e.g. profile, language set, etc. and stores the data properly to the flash ROM 17b. This procedure is described in more detail further below.

In the following, the operation of the terminal will be discussed with focus on the editing of language data sets. The term language set as used here refers to a data set that can be stored in the mobile phone and is used by the user interface to e.g. display information. The language set thus contains all the words to be displayed on the display 3 in accordance with the state of the mobile phone 1.

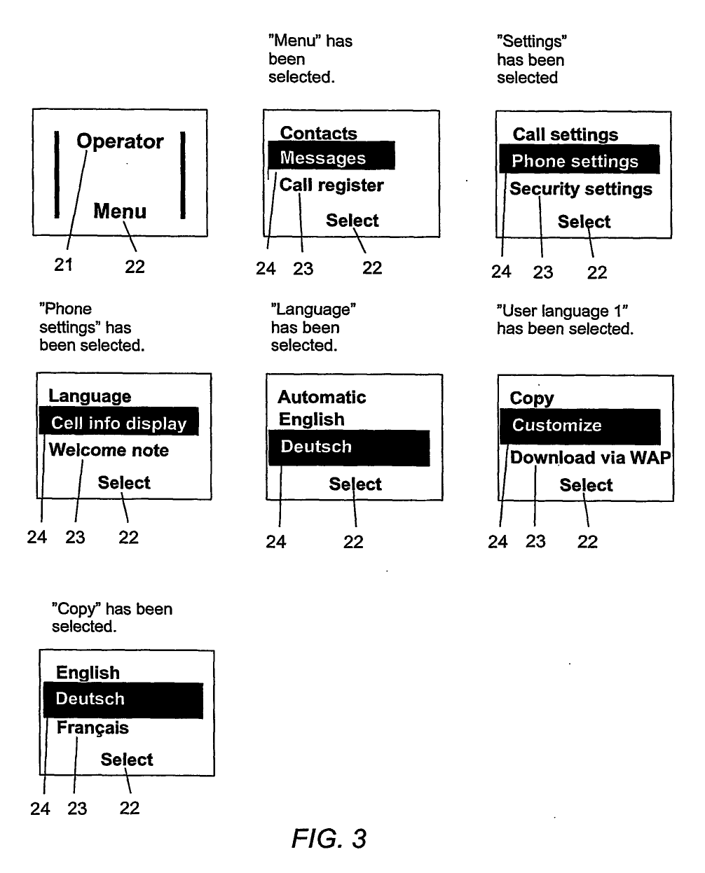

According to a preferred embodiment of the invention the language set may be changed from the menu. The display 3 includes an operator logo 21 and a softkey label 22. The language menu for editing, selection, etc. has to be accessed by selecting “Menu” in idle state (first display of FIG. 3) and thereby entering the menu structure of the phone by pressing the softkey 8.

In the menu, the user has to scroll through the list of selectable items 23 by using the cursor navigation key 10 to move a cursor 24 along the list of selectable items. The fist list displayed after entering the menu will, according to the preferred embodiment of the invention include: “Contacts”, “Messages”, “Call register”, “Tones”, “Settings”, “Call divert”, “Games”, “Calculator”, “Clock”, “Calendar”, “Profiles”. For reaching the langue part of the menu, the user scrolls to the “Settings” menu as illustrated in the second display in FIG. 3, and select the item highlighted by the cursor 24 by pressing the softkey 8 having the softkey label 22 “Select”.

When the user selects “Settings” a new list 23 of selectable items will occur. This list will as indicated in the third display of FIG. 3 include “Call settings”, “Phone Settings”, “Security settings”, “Restore factory settings”. When the user selects “Phone settings”, a new list of selectable items including “Language” will occur (fourth display of FIG. 3). When the user selects “Language”, a list of selectable items will occur—which according to the preferred embodiment will include “Automatic”, “English”, “Deutsch”, “Francais”, “Italiano”, “User language 1” and “User language 2” (fifth window of FIG. 3). When the user selects “User language 1”, the following list of selectable items is displayed: “Copy”, “Customize”, “Download via WAP”, “Receive via infrared”, “Receive via Bluetooth” (sixth window of FIG. 3). If “User language 1” or “User language 2” is selected for the first time, it is empty, and thus, the items “Select” and “Customize” are disabled.

Upon selecting “Copy” (from a pre-installed language) a list of available (installed) languages to be copied is displayed (seventh window of FIG. 3). Selecting one of the languages listed sets the contents of the “User language” equal to one of the pre-installed sets (e.g. English), which then can be edited/modified step by step as shown below.

The user also has the possibility to “Download via WAP” if a service provider or e.g. Club Nokia offers this support. The next two options could for example be to download via Infrared port or using RF signals such as in accordance with the Bluetooth standard in order to receive a language set from another phone. Since it is well known in the art to download data sets to a mobile phone, only aspects directly related to the invention are described below and the complete procedure is not described in detail here.

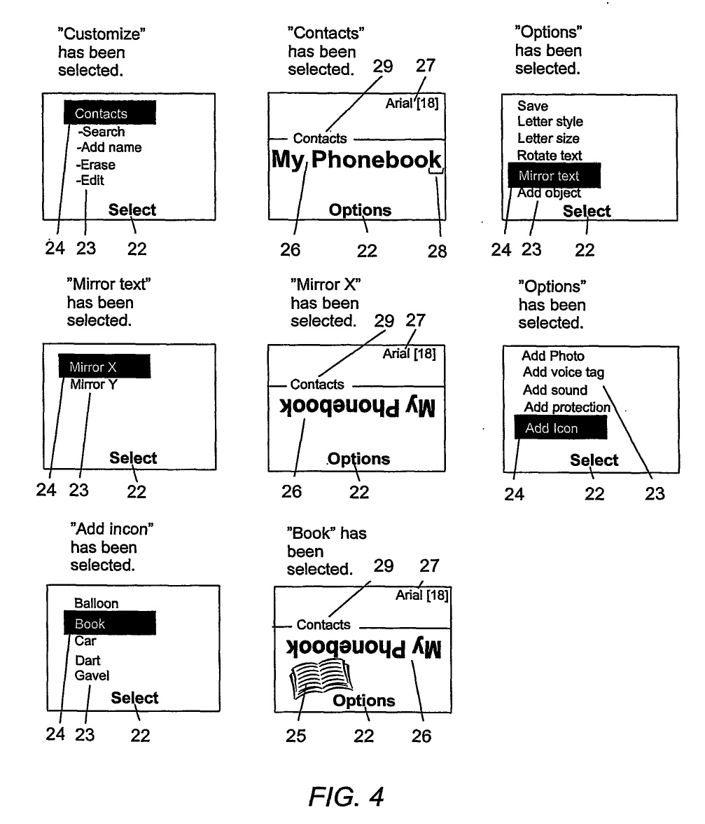

The user language may be edited by selecting “Customize” in the sixth window of FIG. 3. After selecting “Customize” the display will show a list comprising all texts used by the user interface, listed in a manner that reflects the menu structure as shown in the first window of FIG. 4. When the user selects one of the texts, e.g. “Contacts”, the text will be displayed in an editor window as shown in the second window of FIG. 4. This window comprises an editing field 26, a letter style and size indicating field 27, a cursor 28 and a field 29 indicating the original text. In the illustrated case, the user has entered using the alphanumeric keys 7 the text “My Phonebook” to replace the original text “Contacts”. When the user selects “Options”, a list of editing features is displayed including “Save”, “Letter style”, “Letter size”, “Background color”, “Rotate text”, “Mirror text”, “Add object”, “Add voice steam”, “Add sound”, “Add protection code”, “Restore original”, and “Abort” (third window of FIG. 4). When the user selects “Mirror text” a list of mirroring functions is displayed (fourth window of FIG. 4). When the user selects “Mirror X”, the text to be edited is mirrored along the horizontal axis of the display. The user may thereafter also select “Mirror Y”, and the text to be edited is then also mirrored along the vertical axis of the display and the display will look as illustrated in the fifth window of FIG. 4. After pressing “Options” the user cab also add an icon. When the user selects “Add Icon”, from the item list, a list of names of icons will be displayed (seventh window of FIG. 4) and after selection by the user, an icon 25 will be added to the text undergoing editing, as shown in the eighth window of FIG. 4. A list of icons is not given here, but could include any graphical object, image, photo or animation.

In an analogous manner, the user can edit the letter style, the letter size, and rotate the text. Further, the user could add a voice stream to identify, which key has been pressed, for e.g. blind users.

According to another preferred embodiment (not shown) the language set may be changed from an editor in a personal computer (PC) or other external data processor provided with an editing program.

The user language is loaded onto a PC, using a cable, an infrared connection or an RF signal connection. The RF signal connection could be a low power RF signal connection such as in Bluetooth, or a high power RF signal as in WAP. The user language is then edited using an editor on the PC that could be operating nearly identically to the editor in the mobile phone. Preferably, the editor simulates the view of the display of the mobile phone closely, so that the user can see on the screen of the PC what the screen on the mobile phone will look like. The additional possibilities that a PC offers, such as a mouse and a larger screen, could though be exploited and thus allow for a more powerful editing tool. The user language is stored on the PC after editing and loaded onto the mobile phone.

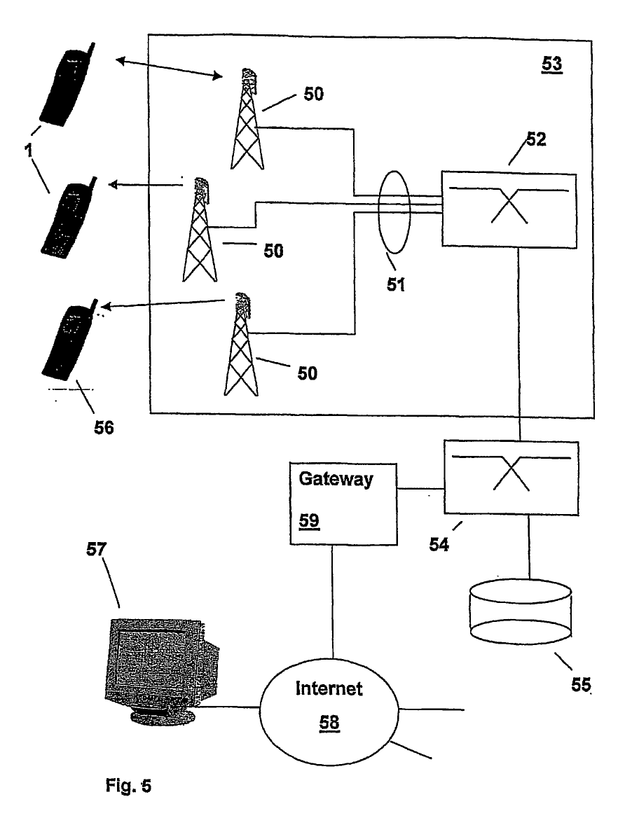

FIG. 5 illustrates in a schematic way the structure of a mobile communications system and connections for communicating via the Wireless Application Protocol (WAP) according to the GSM specification. Mobile stations or cellular phones 1 are connected to base stations 50 (BTS) by means of radio communication. The base stations 50 are further connected, through an Abis interface 51, to a base station controller (BSC) 52, which controls and manages several base stations 50.

The entity formed by a number of base stations 50 and a single base station controller 52 is called a base station system (BSS) 53. The base station controller 52 manages radio communication channels and handovers. Furthermore, the base station controller 52 is connected to a mobile services switching centre (MSC) 54 via a so-called A-interface 55. The mobile services switching centre 54 coordinates the formation of connections both from and to mobile stations. The mobile service switching centre 54 connects the base station system 53 to the world outside the mobile communications network, e.g. the internet.

When a user wants to connect to a WWW page where language sets can be downloaded, a connection via WAP is established. On the WWW page containing the special language set application, the user selects the language set to be downloaded and initiates the download.

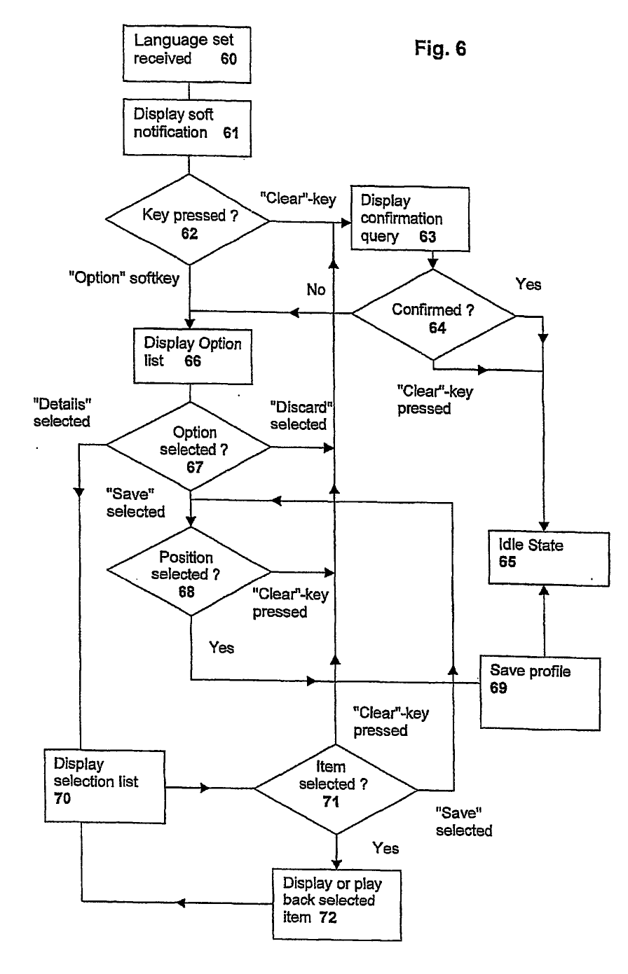

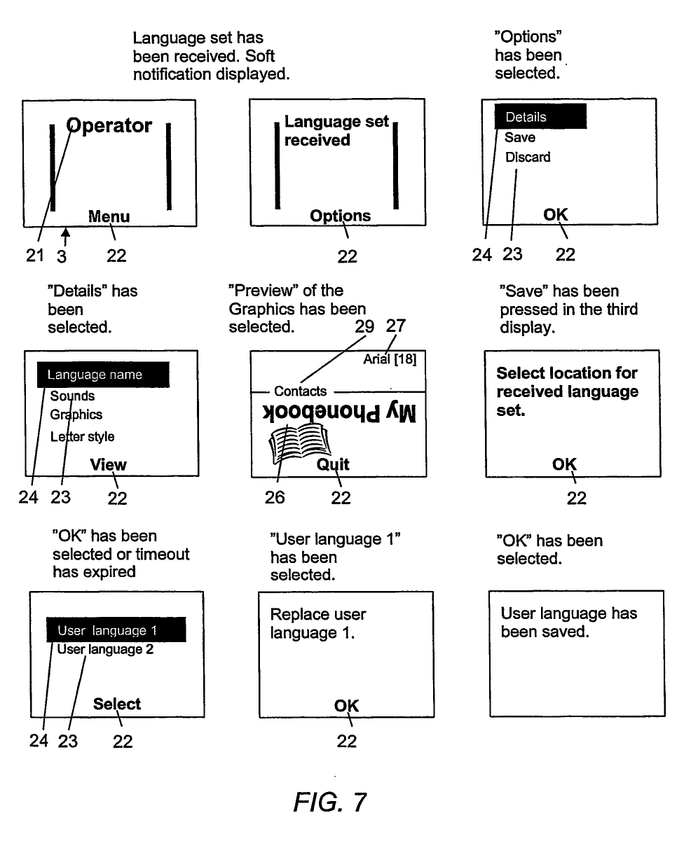

FIGS. 6 and 7 relate to the transmission of a language package via an RF signal to download a language package. FIG. 6 shows a flow chart over the reception of a language package and FIG. 7 shows a sequence of displays for requesting the download and upon reception of the language package. When a language package is downloaded, an alert tone is played. A soft notification 26 “Language set received” is displayed (step 61). Soft notifications inform the user of events that have typically occurred without the user having been involved.

The incoming language package can be discarded by pressing the “Clear key” 9 (step 62). However, after the “Clear key” 9 has been pressed, a confirmation query (step 63) with text “Discard language package” will be displayed. The softkey label of the softkey 8 is “OK”. By pressing the softkey 8 at step 64 the phone exits to idle state (step 65), and discards the received language package without saving it. Pressing the “clear key” 9 instead of confirming the discarding will cancel the operation; in other words, the language package is not deleted and the phone returns to the softkey option list at step 66.

When the user upon the soft notification (the second display of FIG. 7) presses the softkey 8 having the softkey label 22 “Option” the phone 1 displays a selection list (in step 66) of the following selectable items:

Details

Save

Discard

The softkey function is “OK”. By selecting “Details” from the option list shown as the third display of FIG. 7, the phone will display a selection list 23 in step 70 of the selectable items:

“Language name”—when “Language name” is highlighted 24, the softkey label 22 is “view” the name of the language set.

“Sounds”—when “Sounds” is highlighted, the softkey label 22 is “playback” the sounds contained in the language set.

“Graphic”—when “Graphic” is highlighted, the softkey label 22 is “Preview” the graphical layout of the language set.

When the user in step 71 selects the “Preview” softkey 8, the phone will show a sample display of the language set, as shown in the fifth window of FIG. 7. The softkey label will change to “Quit” and the softkey functionality will be quitting the preview. After the previewing is interrupted or finished, the selection list with the selectable items (the fourth display of FIG. 7) is displayed again.

If the user in step 67 selects “Save” from the softkey selection list (third display of FIG. 7), the phone will prompt for a location to save the language set with the display text “Select location for received language set” (sixth window of FIG. 7). After pressing the softkey 22 “OK”, the phone will display a list of locations to save the language set, “User language 1”, “User language 2” (seventh window of FIG. 7). The user can in step 68 select the language set to be replaced.

After the selection, the confirmation query “Replace user language 1” is displayed as an information note (eighths display of FIG. 7). The softkey label 22 is “OK”. If the user confirms, the language set is saved in step 69, and a communication note saying “User language has been saved” is displayed as shown in the ninth display of FIG. 7, and the phone goes to idle state.

Selecting “Discard” from the selection list in step 67, the phone will display the confirmation note query saying “Discard received language set” in step 6. If the user confirms in step 64 by pressing the softkey, the downloaded language set is discarded and a confirmation note saying “Language set discarded” is displayed. After this, the phone goes to idle state.

In an analogues manner, not shown in detail here, a language set can be sent to i.e. another mobile phone. The user can select from the menu an option to select a language set and sends it via IR, or RF directly or via a network.

Although the present invention has been described in detail for purpose of illustration, it is understood that such detail is solely for that purpose, and variations can be made therein by those skilled in the art without departing from the scope of the invention.

Thus, while the preferred embodiments of the devices and methods have been described in reference to the environment in which they were developed, they are merely illustrative of the principles of the invention. Other embodiments and configurations may be devised without departing from the scope of the appended claims.

1. A mobile communication terminal comprising input means, output means for outputting information to a user at least partially in a natural language, means for storing natural language data for a plurality of natural languages, means for selecting one of said natural languages to be used when outputting information through said output means, and means for editing said natural language data.

2. A mobile communication terminal according to claim 1, characterized in that said means for editing said data comprise means for changing and/or replacing words or sentences of said natural language data.

3. A mobile communication terminal according to claim 1, characterized by comprising means for receiving and/or sending a signal incorporating a natural language data set.

4. A mobile communication terminal according to claim 2, wherein said output means comprises a display capable of displaying texts and characterized by comprising means to select a letter style for a text to be displayed on said display.

5. A mobile communication terminal according to claim 1, wherein said output means comprises a color display and characterized by comprising means to select a color for a text and/or text background to be displayed.

6. A mobile communication terminal according to claim 3, wherein said input means comprises a keypad, and said means for editing is responsive to input from said keypad.

7. A mobile communication terminal according to claim 3, wherein said means for editing comprised means for assigning images to a text to be displayed.

8. A mobile communication terminal according to claim 1, wherein said output means comprises a loudspeaker, and said input means comprises a microphone, characterized by comprising means for editing sound signals and means for storing edited sound signals.

9. A mobile communication terminal according to claim 1, wherein said mobile phone comprises a number of user selectable profiles, further comprising means to assign a language package to a certain profile.

10. A mobile communication terminal according to claim 1, wherein said means for editing comprises means for attaching a stored sound signal to a word or sentence of said language data.

11. A mobile communication terminal according to claim 1, wherein said means for editing comprises means for attaching a graphical object to a word or sentence of said language data.

12. A mobile communication terminal having a number of pre-installed user interface languages, each comprising a set of data comprising words, word combinations and/or sentences associated to a particulate message or command and at least one user editable language.

13. A mobile communication terminal according to claim 12, further comprising means for copying a preinstalled language into the user language.

14. A mobile communication terminal according to claim 12, further comprising means for downloading a language into the user language, via cable, infrared or RF communication.

15. A mobile communication terminal according to claim 12, further comprising means to edit the text and/or letter style and/or letter size and/or text orientation and/or text color in the user language.

16. A mobile communication terminal according to claim 12, further comprising means to attach a graphical object or a stored sound signal to a word, word combination or sentence of said user language.

17. A method of individualizing a user interface of a mobile communication terminal, said user interface using at least one natural language data set for inputting and outputting information, comprising the steps of
providing said mobile communication terminal with an editor for editing said natural language data set,
storing said edited natural language data set in a memory of said mobile communication terminal
outputting and inputting information using said stored natural language data set.

18. A method of individualizing a user interface of a mobile communication terminal, said user interface using at least one natural language data set for inputting and outputting information, comprising the steps of
connecting said mobile terminal to a personal computer,
downloading said language data set into said personal computer,
editing said language set on said personal computer, and
sending the edited language set to the mobile communication terminal.
